(19) United States
(12) Patent Application Publication
(10) Pub. No.: US 2011/0279408 A1
(43) Pub. Date: Nov. 17, 2011

(54) TOUCH SCREEN DEVICE

(75) Inventors: Seiji URANO, Fukuoka (JP); Shigeyuki TAKAO, Fukuoka (JP); Shinichi KITAMURA, Fukuoka (JP); Satoru MIYANISHI, Fukuoka (JP)

(73) Assignee: PANASONIC CORPORATION, Osaka (JP)

(21) Appl. No.: 13/107,366

(22) Filed: May 13, 2011

(30) Foreign Application Priority Data
May 17, 2010 (JP) 2010-112818

(51) Int. Cl. G06F 3/044; G06F 3/041

(52) U.S. Cl. 345/174; 345/173

(57) ABSTRACT

The size of a pointing object is determined based on a detection result of a touch operation with a pointing object, and the number of electrodes in a group is switched according to the size of the pointing object. In particular, the size of the pointing object is categorized into three groups based on the size of an adult's finger, a child's finger, and a stylus, and the number of electrodes in a group is set to three levels. The number of electrodes in a group varies according to powers of two, such as two, four, and eight.

### CROSS-REFERENCE TO RELATED APPLICATIONS

The present application claims priority under 35 U.S.C. §119 of Japanese Application No. 2010-112818 filed on May 17, 2010, the disclosure of which is expressly incorporated by reference herein in its entirety.

### BACKGROUND OF THE INVENTION

1. Field of the Invention

The present invention relates to a touch screen device having a plurality of parallel electrodes combined into groups.

2. Description of Related Art

Touch screen devices are widely used in fields of personal computers and mobile information terminals. In combination with a large screen display apparatus, such a touch screen device can be used as an interactive whiteboard used in a presentation or lecture for a large audience.

There are a variety of methods employing different principles to detect a touch position on a touch screen device. For instance, an electrostatic capacitance apparatus is provided with numerous electrodes in a panel to detect a change of electrostatic capacitance in response to a touch operation with a pointing object, such as a finger. In such an electrostatic capacitance apparatus, a calculation amount to obtain a touch position increases according to an increase in the number of electrodes. In case of using a touch screen device as an interactive whiteboard, in particular, the number of electrodes increases according to an increase in the size of the touch screen device, and thus the calculation amount to obtain a touch position increases significantly.

With a lack of processing capacity of a controller relative to the increase in calculation amount, detection of touch positions lags behind touch operations with a pointing object, such as a finger. In handwriting mode, for example, in which a line is drawn following a trajectory of a pointing object moved by a user, a problem occurs such as delay in line drawing, thus causing inconvenience in use. To address this problem, consideration has been given to employing a high performance controller. Employing such a controller, however, leads to a substantial increase in production cost. Furthermore, the increase in processing speed is limited. A configuration is thus demanded in which high speed processing is performed to detect touch positions while a burden of calculation is reduced in the controller.

A conventional technology to meet such a high speed demand is to electrically connect and combine a plurality of parallel electrodes into a predetermined number of groups (refer to Related Arts 1 and 2). In such technology, an apparent number of electrodes is reduced since the electrodes are grouped, thus achieving a reduction in burden of calculation and high speed processing.

Another known technology is to switch between a grouped state of a plurality of electrodes in a predetermined number of groups and an ungrouped state (Related Art 3). The technology roughly detects a touch position in the grouped state of the electrodes, and then switches to the ungrouped state of the electrodes in a vicinity thereof to precisely detect the touch position, thereby achieving high speed processing and ensuring detection accuracy.

A touch screen device as an interactive whiteboard is expected to be used particularly in an educational field, such as a school, where children are likely to use the touch screen device in addition to adults. The child's finger size is significantly different from the adult's finger size. Furthermore, a stylus, which is convenient for writing characters in handwriting mode, has a pen tip contacting a touch surface much smaller than the child's finger.

However, in a case where the size of a pointing object, such as a finger or a stylus, used to perform a touch operation does not match the number of electrodes to be grouped (hereinafter referred to as grouped number), the detection accuracy cannot be sufficiently enhanced. With a variety of sizes in pointing objects, including an adult's finger, a child's finger, and a stylus, a problem arises that it is difficult to enhance the detection accuracy universally, regardless of the size of pointing objects with a constant grouped number as in the conventional technology.
[Related Art 1] Japanese Utility Model Laid-open Publication No. H4-128330
[Related Art 2] Japanese Patent Laid-open Publication No. 2007-257164
[Related Art 3] Japanese Patent Laid-open Publication No. 2009-258903

### SUMMARY OF THE INVENTION

In view of the circumstances above, an objective of the present invention is to provide a touch screen device configured to detect a touch position at a sufficient accuracy regardless of the size of a pointing object that performs a touch operation.

The touch screen device includes a panel main body provided with a touch surface, a plurality of first electrodes provided parallel to each other, and a plurality of second electrodes provided parallel to each other, the first electrodes and the second electrodes being disposed in a grid pattern; a grouper that groups the plurality of electrodes into groups, electrically connecting the electrodes belonging to the same group; and a controller that detects a touch position based on a change in an output signal from the electrodes associated with a change in electrostatic capacitance according to a touch operation by a pointing object on the touch surface, determines a size of the pointing object based on the detection result of the touch operation, and switches a number of electrodes in a group according to the size of the pointing object.

According to the present invention, the number of electrodes in one group is switched according to the size of the pointing object. Accuracy in detecting a touch position can thus be enhanced regardless of the size of the pointing object to perform touch operation.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is an overall configuration view of a touch screen device according to an embodiment of the present invention;

FIGS. 2(a) and 2(b) are cross-sectional views of a panel main body shown in FIG. 1;

FIG. 3 is a schematic configuration view of a receiver shown in FIG. 1;

FIG. 4 is a schematic configuration view of a reception signal processor shown in FIG. 3;

FIGS. 5(a) to 5(c) illustrate a configuration of a reception grouping portion shown in FIG. 3;

FIG. 6 is a schematic configuration view of a transmitter shown in FIG. 1;

FIG. 7 illustrates a relationship between the size of a pointing object and the grouped number in control to switch grouping of transmitting electrodes and receiving electrodes performed in a controller shown in FIG. 1;

FIG. 8 is a flowchart illustrating a procedure of setting the grouped number performed by the controller shown in FIG. 1;

FIG. 9 illustrates an overview of a process of obtaining the size of a pointing object (contact area calculation) shown in FIG. 8;

FIGS. 10(a) to 10(c) illustrate states of electrode intersections according to the grouped number; and

FIGS. 11(a) to 11(c) each illustrate a change ratio of electrostatic capacitance according to a moving distance of a pointing object moved in a direction of an arrow from immediately above a measurement point, each of which is the electrode intersections shown in FIGS. 10(a) to 10(c), respectively.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

The embodiment of the present invention is explained below with reference to the drawings.

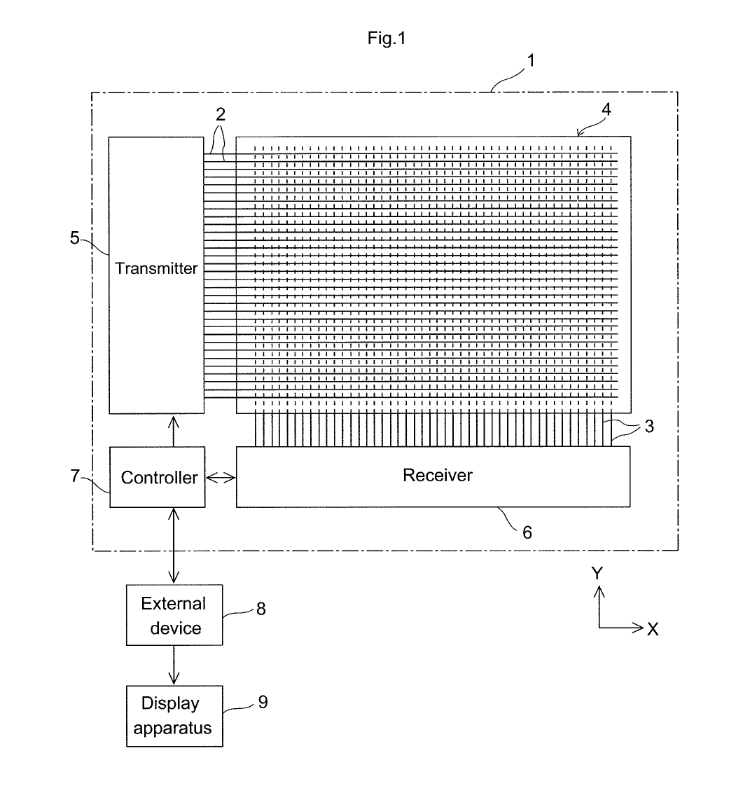

FIG. 1 is a view of an overall configuration of the touch screen device according to the embodiment of the present invention. The touch screen device 1 has a panel main body 4, a transmitter 5, a receiver 6, and a controller 7. The panel main body 4 includes a plurality of transmitting electrodes (first electrodes) 2 provided parallel and a plurality of receiving electrodes (second electrodes) 3 provided parallel, which are disposed in a grid pattern. The transmitter 5 applies a driving signal (pulse signal) to the transmitting electrodes 2. The receiver 6 receives a charge-discharge current signal from the receiving electrodes 3 that have responded to the driving signal applied to the transmitting electrodes 2, and outputs a level signal of each electrode intersection of the transmitting electrode 2 and the receiving electrode 3. The controller 7 detects a touch position based on the level signal output from the receiver 6 and controls the operations of the transmitter 5 and the receiver 6.

Combined with a large-screen display apparatus 9, the touch screen device 1 is used as an interactive whiteboard in a presentation or a lecture. In particular, each member of the panel main body 4 is composed of a transparent material herein. The panel main body 4 is disposed so as to cover a display surface of the display apparatus 9, such as a plasma display or a liquid crystal display, and thus the display screen of the display apparatus 9 can be seen through the panel main body 4. A projector may be used as the display apparatus 9. In this case, a touch surface of the touch screen device 1 is a screen for the projector.

Touch position information output from the touch screen device 1 is input to an external device 8, such as a personal computer. Based on display screen data output from the external device 8, an image is displayed on the display screen of the display apparatus 9 according to a touch operation performed by a user with a pointing object (user's fingertip or a conductor, such as a stylus or a pointer) on the touch surface of the touch screen device 1. A predetermined image can be displayed in a similar manner to directly drawing an image with a marker on the touch surface of the touch screen device 1. Furthermore, a button displayed on the display screen can be operated. In addition, an eraser can be used to erase an image drawn in touch operation.

The transmitting electrodes 2 and the receiving electrodes 3 are disposed at the same pitch (1 mm, for example). The number of electrodes is different depending on the aspect ratio of the panel main body 4. For instance, 960 individual transmitting electrodes 2 may be provided, and 1,488 individual receiving electrodes 3 may be provided.

A mutual capacitance type is employed herein. Applying a driving signal (pulse signal) to the transmitting electrodes 2 generates a charge-discharge current in the receiving electrodes 3 in response. A change in electrostatic capacitance at electrode intersections at this time in response to a user's touch operation causes a change in the charge-discharge current in the receiving electrodes 3. The change amount of the charge-discharge current is converted at the receiver 6 to a level signal (digital signal) of each electrode intersection and is output to the controller 7. The controller 7 calculates a touch position based on the level signal of each electrode intersection. The mutual capacitance type enables multi-touch (multi-point detection) in which a plurality of touch positions are concurrently detected.

The controller 7 obtains the touch position (center coordinate of a touch area) in a predetermined calculation process based on the level signal of each electrode intersection output from the receiver 6. The controller 7 performs the process of obtaining the touch position every frame period at which reception of the level signal ends at each electrode intersection throughout the touch surface. The touch position is output every frame to the external device 8. Based on the touch position information of a plurality of temporally continuous frames, the external device 8 generates image data that connect the touch positions in time-series and outputs the data to the display apparatus 9.

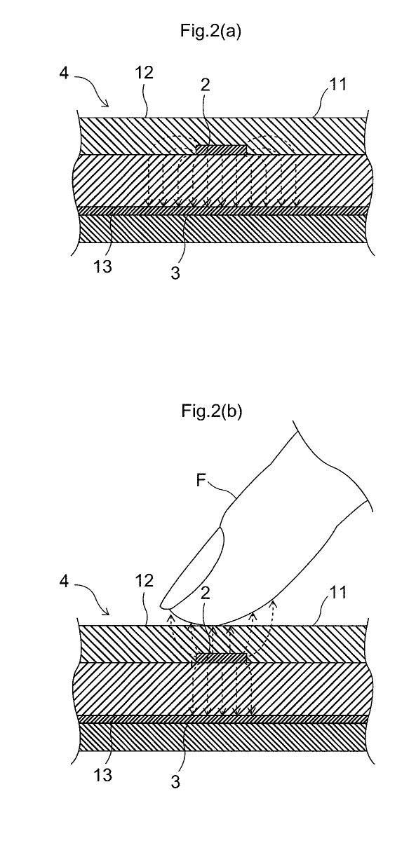

FIGS. 2(a) and 2(b) are cross-sectional views of the panel main body 4 shown in FIG. 1. An electric field (line of electric force) is represented by a broken line in the drawings. FIG. 2(a) illustrates an initial state; and FIG. 2(b) illustrates a state in which a user performs a touch operation with a pointing object, such as a finger F.

The transmitting electrodes 2 and the receiving electrodes 3 are protected on the front side by a protecting insulator 12 provided with a touch surface 11 on which touch operation is performed with a pointing object, such as a finger F. Furthermore, the transmitting electrodes 2 and the receiving electrodes 3 are supported by a support 13. The transmitting electrodes 2 are provided on the front surface of the support 13; and the receiving electrodes 3 are provided on the rear surface of the support 13.

The projecting insulator 12 is preferably composed of a transparent glass material having high permittivity to increase sensitivity in detecting a touch operation with a pointing object, such as a finger F. The support 13 functions as an insulating layer provided between the transmitting electrodes 2 and the receiving electrodes 3 to insulate the electrodes. It is preferred that the support 13 be composed of a glass plate or a film of synthetic resin (for instance, PET, PI, PEN, and PES), but other appropriate materials may be used.

The transmitting electrodes 2 and the receiving electrodes 3 are composed of a conductive opaque metal material and provided with a fine wire diameter (15 μm or less, for example) that does not degrade visibility of the display apparatus 9. Examples of preferable materials to form the transmitting electrodes 2 and the receiving electrodes 3 may include metals having a low resistance value, such as copper and silver, although other appropriate materials may be utilized. Methods of forming the transmitting electrodes 2 and the receiving electrodes 3 may include etching a metal conductive layer (Cu foil, for example) laminated in advance on the support 13 in a predetermined pattern; depositing conductive ink (Ag paste, for example) on the support 13 by gravure printing or screen printing, the conductive ink being dispersed with fine metal particles, such as Ag, in a solvent; and depositing nano-ink on the support 13 by ink-jet printing, the nano-ink being dispersed with super fine metal particles, such as Ag, in a solvent. However, other appropriate materials and fabricating methods can be utilized and are within the scope of the present application.

The configuration is employed herein in which the transmitting electrodes 2 and the receiving electrodes 3 are provided on the front and rear surfaces, respectively, of the support 13. The transmitting electrodes 2 and the receiving electrodes 3 only need to be insulated from each other. Thus, for example, the receiving electrodes 3 may be formed on the front surface of the support, and the transmitting electrodes 2 may be formed on the receiving electrodes 3 with an insulating layer in between. Furthermore, two insulating supports may be used, and the transmission electrodes 2 and the receiving electrodes 3 may be each formed on one surface of each of the supports and be glued and laminated, for example.

The transmission electrodes 2 and the receiving electrodes 3 intersect in a stacked state with the support 13 as an insulating layer in between. A capacitor is formed at the intersection of the transmission electrode 2 and the receiving electrode 3. As shown in FIG. 2(b), when a user performs a touch operation with a pointing object, such as a finger F, and the pointing object approaches or contacts the touch surface 11, electrostatic coupling occurs between the pointing object and the transmitting electrodes 2. In other words, a new capacitor is formed between the pointing object and the transmitting electrodes 2, thus reducing total electrostatic capacitance between the transmission electrodes 2 and the receiving electrodes 3. As a driving signal (pulse signal) is applied to the transmitting electrodes 2, a charge-discharge current generated in the receiving electrodes 3 in response to the driving signal changes in accordance with the change in the electrostatic capacitance associated with the touch operation. Accordingly, whether or not touch operation is performed can be detected based on the change in the charge-discharge current.

In particular herein, the transmitting electrodes 2 are disposed proximate to the touch surface 11, and the receiving electrodes 3 are disposed somewhat more distant from the touch surface 11. Thereby, the distance is short between the pointing object, such as a finger F, and the transmitting electrodes 2 in touch operation, and thus the capacitance of the capacitor formed between the pointing object and the transmitting electrodes 2 is relatively large. Accordingly, the change amount of the charge-discharge current of the receiving electrodes 3 associated with the touch operation with the pointing object is large, thereby improving the sensitivity in detecting the touch position. The thinner the protecting insulator 12 is on the touch surface 11 of the transmitting electrodes 2, the more remarkably the effect is observed.

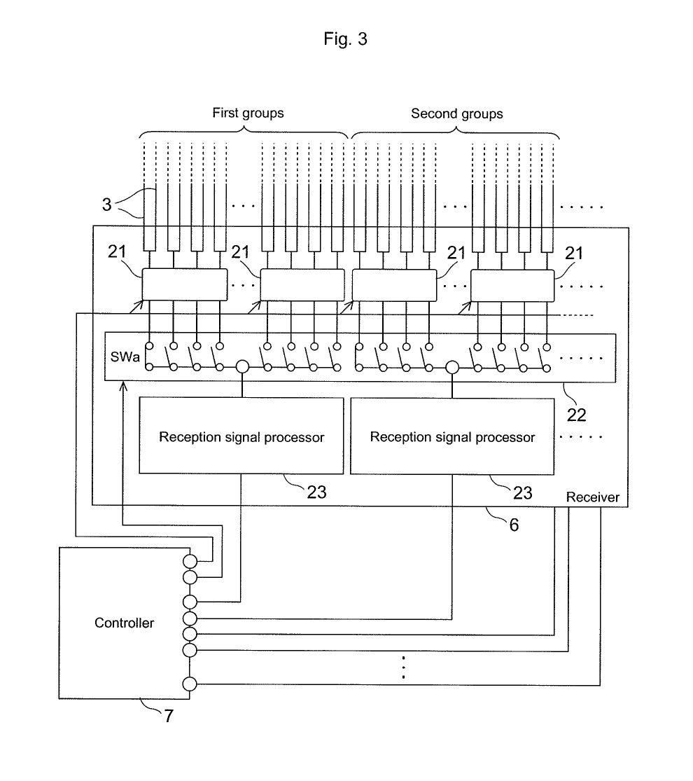

FIG. 3 is a schematic configuration view of the receiver 6 shown in FIG. 1. The receiver 6 has a reception grouping section or grouper 21, an electrode selector 22, and a reception signal processor 23. In the reception grouping section 21, the receiving electrodes 3 are grouped in groups each including predetermined number of electrodes, and the receiving electrodes 3 belonging to the same group are electrically connected. Furthermore, the grouped number (number of electrodes in one group) of the receiving electrodes 3 can be switched.

In the electrode selector 22, a switching element SWa is connected every predetermined number of a minimum unit of grouping (two in this case) of the receiving electrodes 3. While a driving signal is applied to the transmitting electrodes 2, groups of the receiving electrodes 3 are selected one by one, and then charge-discharge current signals from the receiving electrodes 3 are sequentially input to the reception signal processor 23. Each switching element SWa is individually controlled to be turned on and off according to a driving signal from the controller 7.

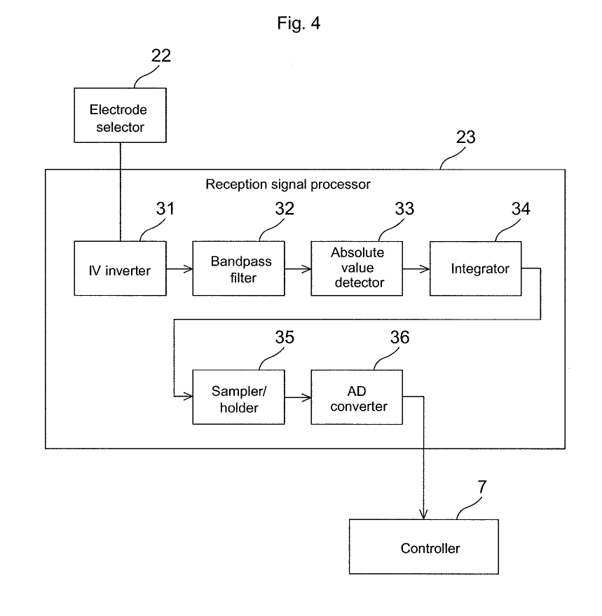

FIG. 4 is a schematic configuration view of the reception signal processor 23 shown in FIG. 3. The reception signal processor 23 has an IV converter 31, a bandpass filter 32, an absolute value detector 33, an integrator 34, a sampler/holder 35, and AD converter 36.

The IV converter 31 converts a charge-discharge current signal (analog signal) from the receiving electrodes 3 input through the electrode selector 22 into a voltage signal. The bandpass filter 32 removes from the output signal from the IV converter 31, a signal having a frequency component other than a frequency of a driving signal applied to the transmitting electrodes 2. The absolute value detector (rectifier) 33 performs full-wave rectification of the output signal from the bandpass filter 32. The integrator 34 integrates the output signal from the absolute value detector 33 in a time axis direction. The sampler/holder 35 samples the output signal from the integrator 34 at a predetermined timing. The AD converter 36 AD-converts the output signal from the sampler/holder 35 and outputs a level signal (digital signal) to the controller 7.

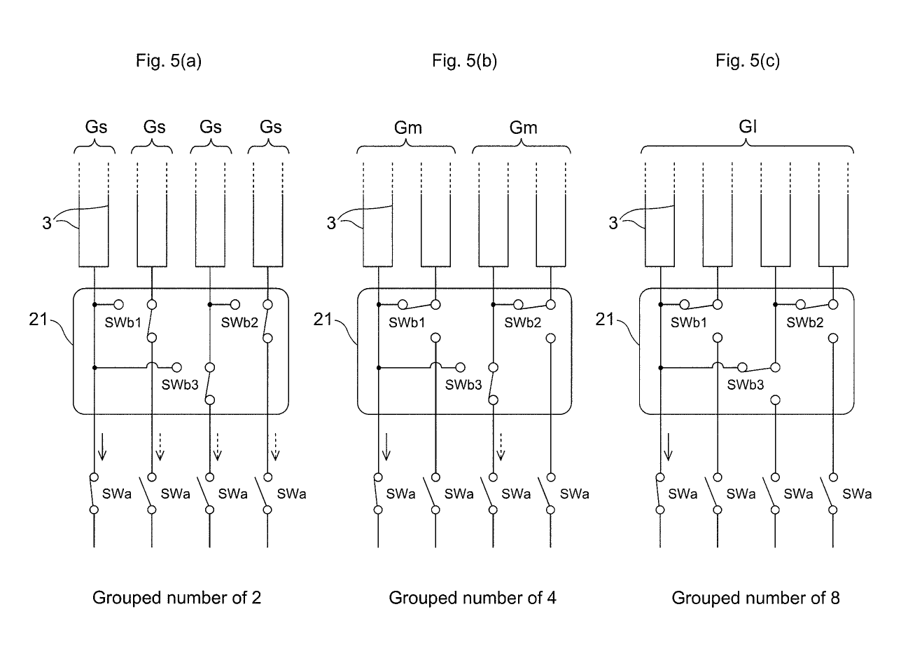

FIGS. 5(a) to 5(c) illustrate a configuration of the reception grouping section 21 shown in FIG. 3. The reception grouping section 21 includes three switching elements SWb1, SWb2, and SWb3. Switching the switching elements SWb1, SWb2, and SWb3 changes the grouped number of the receiving electrodes 3. The switching elements SWb1, SWb2, and SWb3 are individually controlled to be switched according to a driving signal from the controller 7.

In the reception grouping section 21, the receiving electrodes 3 are grouped in levels (hierarchically). A small group Gs having a grouped number of two is the minimum unit of grouping herein. The receiving electrodes 3 are grouped into three levels of the small group Gs, a middle group Gm having a grouped number of four, and a large group Gl having a grouped number of eight. The reception grouping section 21 is provided every eight receiving electrodes 3 in the large group Gl. The switching element SWa, that turns on and off input of a signal from the receiving electrodes 3 to the reception signal processor 23, is provided every small group Gs, which is the minimum unit of grouping.

The middle group Gm integrates two small groups Gs. The large group Gl integrates two middle groups Gm or four small groups Gs. When the total number of receiving electrodes 3 is 1,488, the number of small groups Gs is 744; the number of middle groups Gm is 372; and the number of large group Gl is 186.

The switching elements SWb1, SWb2, and SWb3 each have two contact points, one of which is connected to a switching element SWa and the other is connected to another small group Gs, thus switching between an integrated state and non-integrated state. In the integrated state, two small groups Gs are integrated; in the non-integrated state, two receiving electrodes 3 included in the small group Gs are connected to the switching element SWa.

In the case where the switching elements SWb1, SWb2, and SWb3 are all in the non-integrated state, as shown in FIG. 5(a), the grouped number is two and signals from the two receiving electrodes 3 included in the small group Gs join together and are input to the reception signal processor 23 through the switching element SWa. In the case where the switching elements SWb1 and SWb2 are in the integrated state and the switching element SWb3 is in the non-integrated state, as shown in FIG. 5(b), the grouped number is four and signals from the four receiving electrodes 3 included in the middle group Gm join together and are input to the reception signal processor 23 through the switching element SWa. In the case where the switching elements SWb1, SWb2, and SWb3 are all in the integrated state, as shown in FIG. 5(c), the grouped number is eight and signals from the eight receiving electrodes 3 included in the large group Gl join together and are input to the reception signal processor 23 through the switching element SWa.

The switching elements SWa, which each turn on an off input of a signal from the receiving electrodes 3 to the reception signal processor 23, need to be controlled to be turned on one by one in sequence in the case of the grouped number of two. In the case of the grouped number of four and eight, some of the switching elements SWa are not supplied with a signal. Thus, only the switching elements SWa supplied with a signal may be sequentially controlled to be turned on, and the remaining switching elements SWa supplied with no signal may be controlled not to be turned on.

The grouped number is powers of two, such as two, four, and eight, as described above. Thus, the control sequence can be simplified to switch the grouping of the receiving electrodes 3.

As shown in FIG. 3, the receiving electrodes 3 are formed into groups combining the small groups Gs, the middle groups Gm, and the large groups Gl according to the predetermined numbers. Each group of the receiving electrodes 3 is provided with one reception signal processor 23. The switching elements SWa of the electrode selector 22 are also grouped so as to correspond to the groups of the receiving electrodes 3.

When one group includes 48 receiving electrodes 3 and the total number of the receiving electrodes 3 is 1,488, for example, 31 groups exist. In this case, one group includes 24 small groups Gs each having two receiving electrodes 3; 12 middle groups Gm each having four receiving electrodes 3; or six large groups Gl each having eight receiving electrodes 3.

In each group, the switching elements SWa are controlled to be turned on one by one in sequence. While one switching element SWa is on, the other switching elements SWa in the same group are off. A charge-discharge current signal from the receiving electrodes 3 that belong to one group selected by turning the switching element SWa on is input to the reception signal processor 23.

Thereby, switching operations of the switching elements SWa of the electrode selector 22 can be performed in parallel among the groups, thus reducing the time to receive charge-discharge current signals from all the receiving electrodes 3. Furthermore, processing of the charge-discharge current signals in the receiver 6 can be divided and performed on a per group basis, thus preventing the need to provide a large hardware configuration.

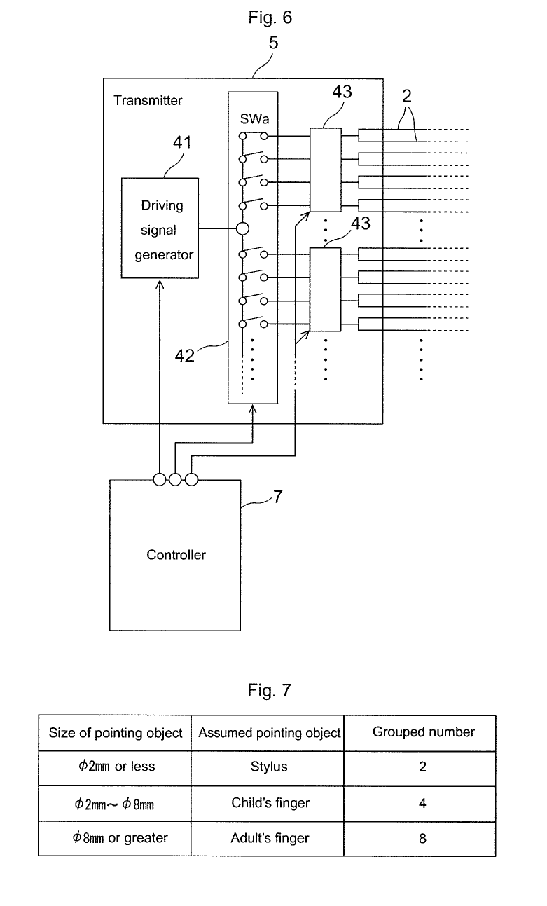

FIG. 6 is a schematic configuration view of the transmitter 5 shown in FIG. 1. The transmitter 5 has a driving signal generator 41, an electrode selector 42, and a transmission grouping section 43. The driving signal generator 41 generates a driving signal (pulse signal) in synchronization with a timing signal output from the controller 7.

In the electrode selector 42, a switching element SWa is connected every predetermined number of a minimum unit of grouping (two in this case) of the transmitting electrodes 2. Groups of the transmitting electrodes 2 are selected one by one, and then charge-discharge current signals output from the driving signal generator 41 are sequentially applied to the transmitting electrodes 2. Each switching element SWa is individually controlled to be turned on and off according to a driving signal from the controller 7.

In the transmission grouping section 43, the transmitting electrodes 2 are grouped in a predetermined number of pieces, and the transmitting electrodes 2 belonging to the same group are electrically connected. Furthermore, the grouped number of the transmitting electrodes 2 in grouping can be switched. The configuration of the transmission grouping section 43 is similar to that of the reception grouping section 21 shown in FIGS. 5(a) to 5(c). Switching elements provided thereinside are individually switched and controlled according to a driving signal from the controller 7.

In the transmission grouping section 43, the transmitting electrodes 2 are grouped in a similar manner to the reception grouping section 21. Specifically, a small group Gs having a grouped number of two is the minimum unit of grouping; and the transmitting electrodes 2 are grouped into three levels of the small group Gs, a middle group Gm having a grouped number of four, and a large group Gl having a grouped number of eight. The transmission grouping section 43 is provided every eight transmission electrodes 2 in the large group Gl. The switching element SWa to turn on and off input of a signal from the driving signal generator 41 to the transmitting electrodes 2 is provided every small group Gs, which is the minimum unit of grouping.

FIG. 7 illustrates a relationship between the size of a pointing object and the grouped number in control to switch the grouping of the transmitting electrodes 2 and the receiving electrodes 3 performed in the controller 7 shown in FIG. 1. The controller 7 determines the size of a pointing object based on detection results of a touch operation with the pointing object, and then switches the grouped number in the reception grouping section 21 and the transmission grouping section 43 according to the size of the pointing object.

In particular herein, pointing objects are categorized into three sizes based on the size of an adult's finger, a child's finger, and a stylus. Furthermore, the grouped number in the reception grouping section 21 and the transmission grouping section 43 is set to three levels, in which the grouped number increases as the size of the pointing object becomes larger.

Specifically, the size of the pointing object is categorized into three cases of φ2 mm or less, φ2 mm to φ8 mm, and φ8 mm or greater. In the case of φ2 mm or less, the grouped number is set to two. In the case of φ2 mm to φ8 mm, the grouped number is set to four. In the case of φ8 mm or greater, the grouped number is set to eight. A stylus is assumed for a size of a pointing object of φ2 mm or less. A child's finer is assumed for a size of a pointing object of φ2 mm to φ8 mm. An adult's finger is assumed for a size of a pointing object of φ8 mm or greater.

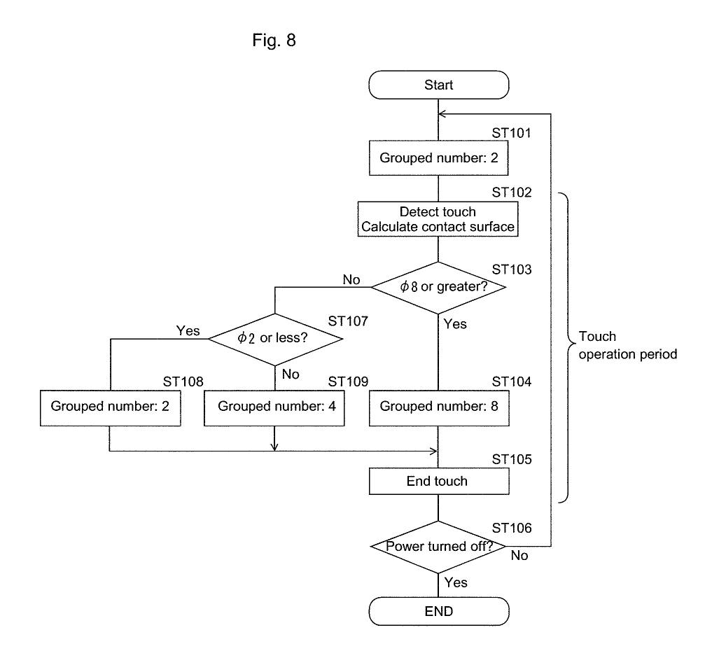

FIG. 8 is a flowchart illustrating a procedure of setting the grouped number performed in the controller 7 shown in FIG. 1. In response to power supply to the touch screen device 1, the grouped number of the transmitting electrodes 2 and the receiving electrodes 3 is set to two (ST101). An operation to detect a touch position is then started. When a touch operation with a pointing object, such as a finger, is detected, the size of the pointing object is obtained (contact surface calculation) (ST102).

Subsequently, depending on determination whether or not the size of the pointing object is φ8 mm or greater (ST103) and whether or not it is φ2 mm or less (ST107), the size is categorized into one of the three cases of φ2 mm or less, φ2 mm to φ8 mm, and φ8 mm or greater.

Then, the grouped number is set according to the size of the pointing object. In the case of φ2 mm or less (Yes in ST107), the grouped number is set to two (ST108). In the case of φ2 mm to φ8 mm (No in ST107), the grouped number is set to four (ST109). In the case of φ8 mm or greater (Yes in ST103), the grouped number is set to eight (ST104).

After the grouped number is set as above, the touch position is detected. Subsequently, the user removes the pointing object from the touch surface, and then the end of the touch operation is detected (ST105). When the power is not turned off (No in ST106), the grouped number is returned to two and the apparatus is in standby mode for a new touch operation (ST101 and thereafter).

As described above, the controller 7 changes the grouped number every touch operation period which is from detection of a touch operation with a pointing object through the end of the touch operation. In other words, every time a touch operation with a pointing object occurs, the grouped number is changed to be suitable or appropriate for the size of the pointing object. Thereby, the touch position can be detected in the grouped number appropriate for the size of the pointing object that performs the touch operation.

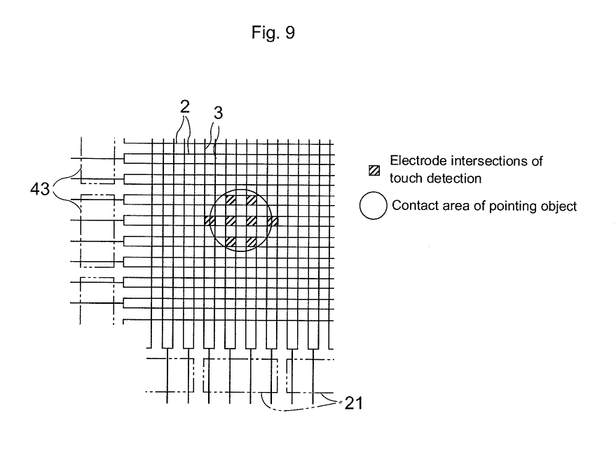

FIG. 9 illustrates an overview of a process of obtaining the size of the pointing object (contact area calculation) shown in FIG. 8. In determination of the size of the pointing object, the controller 7 sets the minimum grouped number (two herein) and obtains the number of electrode intersections included in the contact area of the pointing object on the touch surface. The controller then determines the size of the pointing object based on the number of electrode intersections.

As described above, the controller 7, to which a level signal of each electrode intersection is input from the receiver 6, calculates for all electrode intersections a touch position every frame period at which reception of the level signal ends. The controller 7 compares the level signal of each electrode intersection against a predetermined threshold, and thereby determines whether or not the electrode intersection is included in the contact area of the pointing object on the touch surface.

Furthermore, the grouped number is set to a minimum of two, and thus the electrode intersection is a small area. Accordingly, the size of the pointing object can be determined simply and accurately, even if the pointing object is small.

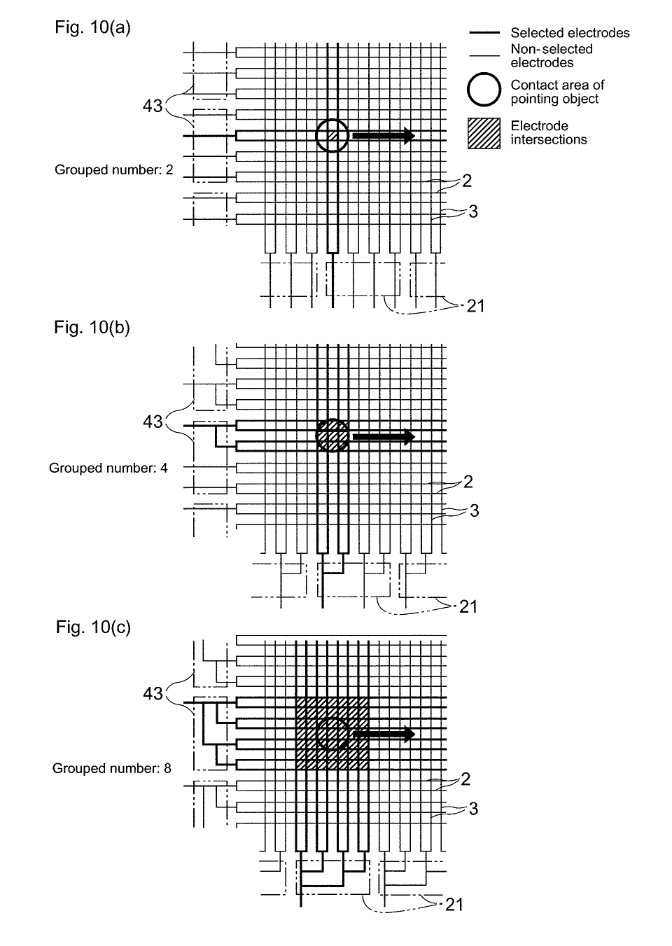

FIGS. 10(a) to 10(c) illustrate a state of an electrode intersection according to the grouped number shown in FIGS. 5(a) to 5(c). FIG. 10(a) illustrates a case of a grouped number of two; FIG. 10(b) illustrates a case of a grouped number of four; and FIG. 10(c) illustrates a case of a grouped number of eight.

When the grouped number is increased, an apparent number of electrodes is reduced, and the number of electrode intersections is reduced. Thus, a calculation load to obtain a touch position in the controller 7 is reduced, and touch position detection can be performed at high speed. Furthermore, when the grouped number is increased, the size of the electrode intersection is increased. Thus, a change amount of a charge-discharge current signal is increased, in the signal being input from the receiving electrodes 3 to the reception signal processor 23 according to a touch operation of a pointing object. Thereby, sensitivity in touch position detection can be improved.

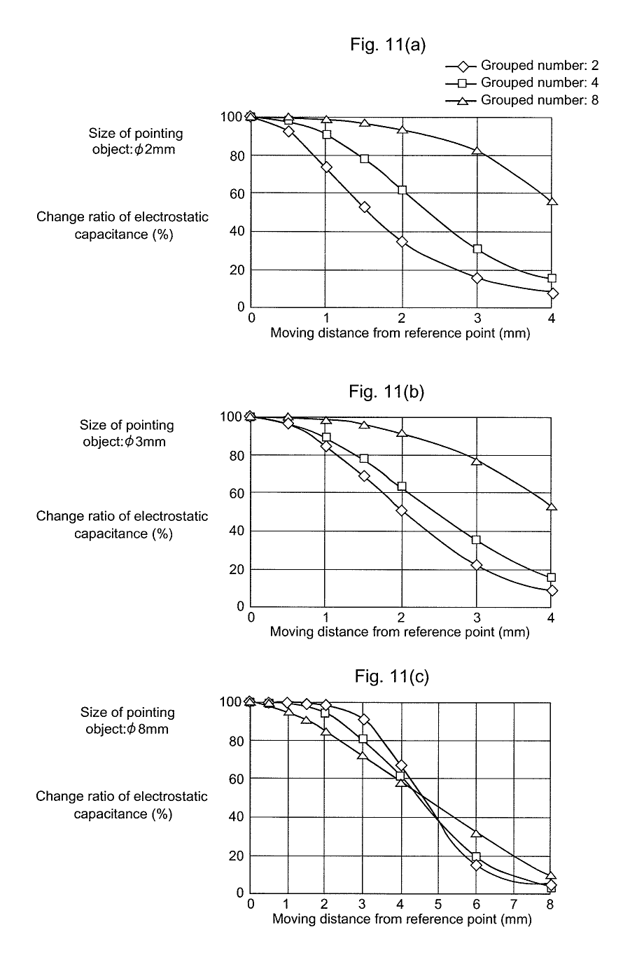

FIGS. 11(a) to 11(c) illustrate a change ratio of electrostatic capacitance according to a moving distance of a pointing object moved in the direction of the arrow from immediately above a measurement point, which is the electrode intersection shown in FIGS. 10(a) to 10(c). The change ratio of electrostatic capacitance refers to a ratio of ΔC/ΔC_{O} (%), which represents a change amount ΔC of electrostatic capacitance at the measurement point when the pointing object touches a position away from the measurement point relative to a change amount ΔC_{O} of electrostatic capacitance at the measurement point when the pointing object touches immediately above the measurement point.

As shown in FIG. 11(a), with a pointing object having a size of φ2 mm, a decline in the change ratio of electrostatic capacitance is extremely small in an area proximate to the measurement point, specifically in an area of a moving distance of 2 mm or less, in the case of a grouped number of eight. Thus, accuracy in touch point detection significantly declines. In contrast, in the cases of grouped numbers of two and four, the decline in the change ratio of electrostatic capacitance is large in the area proximate to the measurement point. In the case of a grouped number of two in particular, the decline in the change ratio of electrostatic capacitance is the largest and high detection accuracy is obtained.

As shown in FIG. 11(b), with a pointing object having a size of φ3 mm, the decline in the change ratio of electrostatic capacitance is extremely small in the area proximate to the measurement point in the case of a grouped number of eight. Thus, accuracy in touch point detection significantly declines. In contrast, in the cases of grouped numbers of two and four, the decline in the change ratio of electrostatic capacitance is large in the area proximate to the measurement point. Thus, high detection accuracy is obtained. When the cases of grouped numbers of two and four are compared, there is no substantial difference in accuracy since the change state of electrostatic capacitance is similar, but the case of a grouped number of four is superior in high linearity.

In contrast to the cases above, with a pointing object having a size of φ8 mm, the decline in the change ratio of electrostatic capacitance is extremely small in the area proximate to the measurement point in the cases of grouped numbers of two and four, as shown in FIG. 11(c). Thus, accuracy in touch point detection significantly declines. In contrast, in the case of a grouped number of eight, the decline in the change ratio of electrostatic capacitance is large in the area proximate to the measurement point. Thus, high detection accuracy is obtained.

As described above, an adult's finger is assumed as the pointing object having a size of φ8 mm or greater. In case of an adult, a range of finger motion is large and the move is fast since an adult moves a finger over a relatively large distance to draw large characters or figures when drawing characters or figures in handwriting mode. In addition, in case of gesture operation which instructs or controls program operation with a finger motion, a range of finger motion is large and the move is fast. Thus, high speed is required in touch position detection such that the touch point detection surely follows the finger motion.

As shown in FIG. 11(c), with the pointing object having a size of φ8 mm, the decline in the change ratio of electrostatic capacitance is large in the case of a grouped number of eight, thus achieving high detection accuracy. Furthermore, with a grouped number of eight, a calculation load is reduced because the grouped number is large, thus allowing fast processing. Accordingly, a grouped number of eight is optimum for the pointing object having a size of φ8 mm or greater. Thus, touch position detection can be performed effectively in response to touch operation with an adult's finger.

A child's finger is assumed as the pointing object having a size of φ2 mm to φ8 mm. In case of a child, a range of finger motion is small and the move is slow since a child moves a finger relatively finely to draw small characters or figures when drawing characters or figures in handwriting mode. Thus, high accuracy is required in touch position detection. Similar to the case of an adult, a certain level of speed in touch position detection is also required in the case of gesture operation with a finger.

As shown in FIG. 11(b), with the pointing object having a size of φ3 mm, the decline in the change ratio of electrostatic capacitance is large in the case of grouped numbers of two and four, thus achieving high detection accuracy. With a grouped number of four, in particular, a calculation load is reduced because the grouped number is large, thus allowing fast processing. Accordingly, a grouped number of four is optimum for the pointing object having a size of φ2 mm to φ8 mm. Thus, touch position detection can be performed effectively in response to touch operation with a child's finger.

A stylus is assumed as the pointing object having a size of φ2 mm or less. A stylus is used to draw characters and relatively small figures in handwriting mode, and a range of stylus movement is small and the movement is slow. Thus, high speed is not so much required in touch position detection and high accuracy is required instead.

As shown in FIG. 11(a), with the pointing object having a size of φ2 mm, the decline in the change ratio of electrostatic capacitance is large in the case of a grouped number of two, thus achieving high detection accuracy. Accordingly, a grouped number of two is optimum for the pointing object having a size of φ2 mm or less. Thus, touch position detection can be performed effectively in response to touch operation with a stylus.

Changing the grouped number according to the size of the pointing object as above improves the accuracy in touch position detection and effectively detects touch positions according to characteristics of touch operations with assumed size pointing objects. In particular, categorizing the size of the pointing object into three groups based on the size of an adult's finger, a child's finger, and a stylus and setting the grouped number to three levels provides an easy-to-use touch screen device in an environment where an adult and a child are occasional users along with a stylus pen, such as in, as a non-limiting example, an educational field, including a school.

The touch screen device employs a mutual capacitance type that allows multi-touch to detect a plurality of touch positions concurrently. Even in a case where a touch operation with a pointing object occurs during a touch operation with a pointing object of a different size, the touch screen device may be designed to detect touch positions with an appropriate group number for each pointing object.

In this case, it is possible to select an optimum grouped number according to a difference in size of a plurality of pointing objects. It is also possible to switch among grouped numbers corresponding to the size of the pointing objects in a unit of frame (i.e., per frame) or every predetermined number of frames. Furthermore, since it is necessary to determine the size of the pointing object during a touch operation, an inspection frame may be inserted between position detection frames at an appropriate timing, the inspection frame setting the minimum grouped number and determining the size of the pointing object, and the position detection frames actually detecting the touch position.

The minimum unit of grouping the transmitting electrodes 2 and the receiving electrodes 3 is two in the embodiment above. The minimum unit of grouping may be one, or three or more, and may be appropriately set according to the smallest size of the pointing object or the placement pitch of the transmitting electrodes 2 and the receiving electrodes 3.

In the embodiment of the touch screen device described above, a mutual capacitance type is employed from among an electrostatic capacitance type. A self capacitance type may also be employed.

The touch screen device according to the present invention is useful as a touch screen device capable of detecting a touch position at a sufficient accuracy regardless of the size of a pointing object that performs a touch operation, efficiently detecting a touch position according to characteristics of touch operations with assumed pointing objects, and having a plurality of parallel electrodes grouped into a predetermined number of groups.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its various aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A touch screen device comprising:
a panel main body comprising:
a touch surface;
a plurality of first electrodes provided parallel to each other; and
a plurality of second electrodes provided parallel to each other, the first electrodes and the second electrodes being disposed in a grid pattern;
a grouper that groups the plurality of electrodes into groups, electrically connecting the electrodes belonging to the same group; and
a controller that detects a touch position based on a change in an output signal from the electrodes associated with a change in electrostatic capacitance according to a touch operation by a pointing object on the touch surface, determines a size of the pointing object based on the detection result of the touch operation, and switches a number of electrodes in a group according to the size of the pointing object.

2. The touch screen device according to claim 1, wherein the controller switches the number of electrodes in a group at every touch operation period from detection of a touch operation with the pointing object to an end of the touch operation.

3. The touch screen device according to claim 1, wherein the controller sets a minimum number of electrodes in determination of the size of the pointing object, obtains the number of electrode intersections included in a contact area of the pointing object on the touch surface, and determines the size of the pointing object based on the number of the electrode intersections.

4. The touch screen device according to claim 1, wherein a driving signal is applied to the first electrodes; a charge-discharge current signal of the second electrodes responding to the driving signal is received; a level signal at each electrode intersection is obtained; and a touch position is detected based on the level signal; and
the first electrodes are disposed proximate to the touch surface, and the second electrodes are disposed further from the touch surface than the first electrodes.

5. The touch screen device according to claim 1, wherein the touch screen device is disposed so as to cover a display surface of a display apparatus; and
the electrodes are composed of an opaque metal material having a wire diameter not degrading visibility of the display apparatus.

6. The touch screen device according to claim 1, wherein the grouper groups the electrodes such that the number of electrodes in a group varies according to powers of two.

7. The touch screen device according to claim 6, wherein the number of electrodes in a group is switched at least between 2 and 4.

8. The touch screen device according to claim 6, wherein the number of electrodes in a group is switched at least between 2 and 8.

9. The touch screen device according to claim 6, wherein the number of electrodes in a group is switched at least between 4 and 8.

10. The touch screen device according to claim 1, wherein the pointing object is categorized into at least a finger and a stylus.

11. The touch screen device according to claim 10, wherein a size of the stylus is φ2 mm or less.

12. The touch screen device according to claim 1, wherein the pointing object is categorized into at least an adult's finger and a child's finger.

13. The touch screen device according to claim 12, wherein a size of the adult's finger is φ8 mm or more.

14. The touch screen device according to claim 1, wherein the controller switches the number of electrodes every predetermined number of frames.

15. The touch screen device according to claim 1, wherein the controller is configured to insert an inspection frame between position detecting frames at a predetermined timing, the inspection frame setting the minimum number of electrodes in a group and determining the size of the pointing object, the position detecting frames detecting the touch position.

16. The touch screen device according to claim 1, wherein the pointing device is categorized into at least an adult's finger, a child's finger and a stylus.

17. The touch screen device according to claim 1, wherein when the size of the pointing object is determined to be smaller than a first predetermined size, the pointing object is determined to be a stylus and a minimum number of electrodes are grouped together, when the size of the pointing object is determined to be larger than a second predetermined size, the pointing object is determined to be an adult's finger and a maximum number of electrodes are grouped together, and when the size of the pointing object is determined to be between the first predetermined size and the second predetermined size, the pointing object is determined to be a child's finger and an intermediate number of electrodes are grouped together.

18. The touch screen device according to claim 1, wherein the plurality of first electrodes and the plurality of second electrodes define a mutual capacitance type touch screen device.

19. The touch screen device according to claim 1, wherein the plurality of first electrodes and the plurality of second electrodes define a self capacitance type touch screen device.

20. The touch screen device according to claim 1, said controller being configured to output display screen data to an external device to display an image on a display screen based on a touch operation performed by a user of the touch screen device.
